(19) United States
(12) Patent Application Publication
(10) Pub. No.: US 2004/0134333 A1
(43) Pub. Date: Jul. 15, 2004

(54) Drum tensioning device

(75) Inventor: James H. May, Palmdale, CA (US)

Correspondence Address: Larry F. Gitlin, RAPKIN & GITLIN, Suite 301, 5855 Topanga Canyon Boulevard, Woodland Hills, CA, 91367-4620, US

(73) Assignee: REMO, INC.

(21) Appl. No.: 10/340,372

(22) Filed: Jan. 10, 2003

(51) Int. Cl. G10D 13/02

(52) U.S. Cl. 84/413

(57) ABSTRACT

In combination with a drum, which includes a drumshell, a flesh hoop, a counter-hoop and a drumhead with a drumming surface, a device for tensioning a drumhead that eliminates protruding and awkwardly designed components and protects against the associated physical discomfort to the musician which interferes with the enjoyment of playing the instrument and the musician's playing technique. The tensioning device includes a conventional mechanical worm-drive mechanism for applying a tensioning force substantially perpendicular to the drumming surface toward the flesh hoop to the counter-hoop to increase the tension of the drumming surface. One end of the tensioning device is affixed securely to the drumshell and the other end of the device is tightly attached to the counter-hoop. The tensioning device is also comprised of two or more generally flat, ribbon-like bands disposed in a low-profile fashion about the perimeter of the shell. A series of spaced apart parallel slots are disposed along sections of at least one of the bands to engage components in the worm-drive to enable the adjustment of the tension in the drumming surface.

### BACKGROUND OF THE INVENTION

1. Field of the Invention

The present invention relates generally to the area of musical instruments. More particularly, the invention is directed to certain musical drums and a device for tensioning the drumheads which effectively eliminate the obstacles and related discomfort that often interfere with playing technique and the enjoyment of playing the instrument.

2. Description of the Prior Art

Devices used for tensioning and tuning drumheads are numerous and vary widely. Some versions include a claw like device, which grips the counterhoop, attached to a tuning rod that, depending on the direction the rod is rotated, lessens or increases the tension of the drumhead. Conventional lugs in combination with tunning rods are also employed for the same purpose. Another type of tuning mechanism is a modified version of these two devices. It includes a v-shaped bracket attached to the counterhoop, and a tuning rod with a hooked end to engage the bracket. The other end of the rod is inserted through the lug affixed to the drumshell. None of these devices are considered “low profile” due to the protruding and sometimes ungainly character of their components.

Drums that employ these and similar devices, which include, among others, Djembes, Bongos and Doumbeks, are drums that are typically played using the hands (instead of a stick or mallet) to strike the drumhead. In these cases, the drums are usually held close to the body and in some instances supported or cradled between the musician's legs. Any component of the tensioning mechanism that protrudes into the hands, as the hands strike the instrument, or into the legs, as the instrument is held and supported, will not only inhibit playing technique, but will likely in the process cause discomfort and possibly some significant pain to the musician.

Accordingly, there is a need in the art to provide a tensioning device for a drumhead that employs components and mounting fixtures which, in combination, are capable of effectively, conveniently and easily tensioning the head while, at the same time, do not interfere with or inhibit the playing of the instrument, particularly the musician's playing technique.

### SUMMARY OF THE INVENTION

The present invention provides a device for tensioning a drumhead that eliminates protruding and awkwardly designed components and protects against the associated physical discomfort to the musician that interferes with the enjoyment of playing the instrument and especially the musician's playing technique. The invention comprises a drum, which includes a drumshell, a flesh hoop, a counter-hoop and a drumhead with a drumming surface. Attached to the drum is a tensioning device with a conventional mechanical worm-drive mechanism for applying a tensioning force substantially perpendicular to the drumming surface toward the flesh hoop to the counter-hoop to increase the tension of the drumming surface. One end of the tensioning device is affixed securely to the drumshell. The other end of the device is tightly attached to the counter-hoop. The tensioning device is also comprised of two or more generally flat, ribbon-like bands disposed in a low profile fashion about the perimeter of the shell. A series of spaced apart parallel slots are disposed along sections of at least one of the bands to engage components in the worm-drive to enable the adjustment of the tension in the drumming surface. Rotating the worm-drive screw or rod component causes the bands to tighten and the two to essentially pull the counter-hoop in their direction. This causes the counter-hoop to pull against the flesh hoop and, in turn, the drumming surface and, thus, increase the tension in the head.

Accordingly, an object of the present invention is to provide a device for tensioning a drumhead that includes components that help to eliminate pain and physical discomfort to a musician's hands and legs when holding and playing the drum in close.

Another object of the present invention is to provide a device for tensioning a drumhead that does not inhibit the musician's playing technique.

Another object of the present invention is to provide a device for tensioning a drumhead that facilitates the tensioning process.

Still another object of the present invention is to provide a device for tensioning a drumhead that enables the exertion of higher than normal tension in the drumhead.

Still another object of the present invention is to provide a device for tensioning a drumhead that provides for and maintains a device with a compact, flat in-line profile that generally conforms to the configuration of the drumshell.

Still another object of the present invention is to provide a device for tensioning a drumhead that has a superior strength to weight ratio.

Still another object of the present invention is to provide a device for tensioning a drumhead that is relatively lightweight.

Still another object of the present invention is to provide a device for tensioning a drumhead that eliminates the use of threaded screws, rods, or hooks that can protrude into portions of a musician's body and hamper play.

Still another object of the present invention is to provide a device for tensioning a drumhead that is easy for the musician to operate and adjust.

Still another object of the present invention is to provide a device for tensioning a drumhead that is easy and cost effective to manufacture.

Other objects and advantages of the present invention will become apparent in the following specifications when considered in light of the attached drawings wherein the preferred embodiment of the invention is illustrated.

### BRIEF DESCRIPTION OF THE DRAWINGS

FIG. 1 is a perspective view of the device of the present invention shown attached to a Djembe.

FIG. 2 is an enlarged perspective view of the device of the present invention shown connected to a section of a drum with a section of the flesh hoop shown in phantom.

FIG. 3 is a perspective view of the device of the present invention shown attached to a drum held and played between a drummer's legs.

FIG. 4 is an enlarged perspective view of the detached ribbon-like bands of the device in accordance with the present invention.

FIG. 5 is an enlarged perspective view of the attached ribbon-like bands of the device in accordance with the present invention.

### DETAILED DESCRIPTION OF THE PREFERRED EMBODIMENT

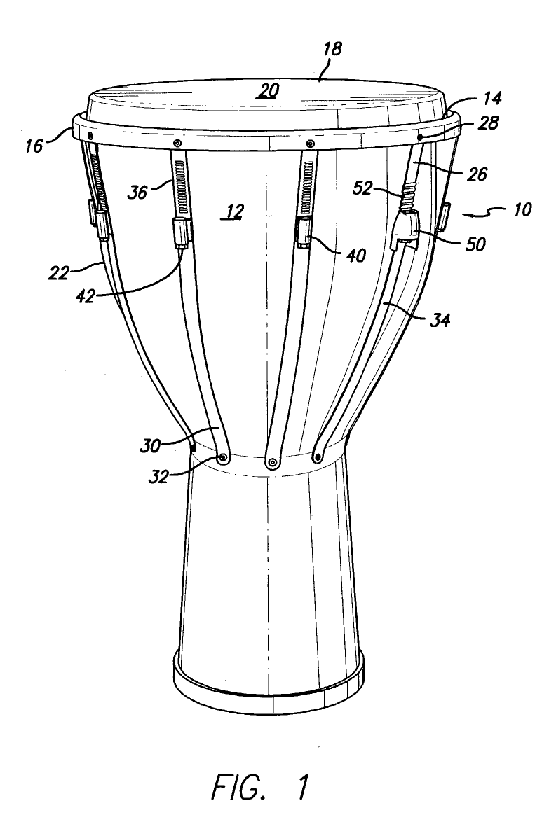

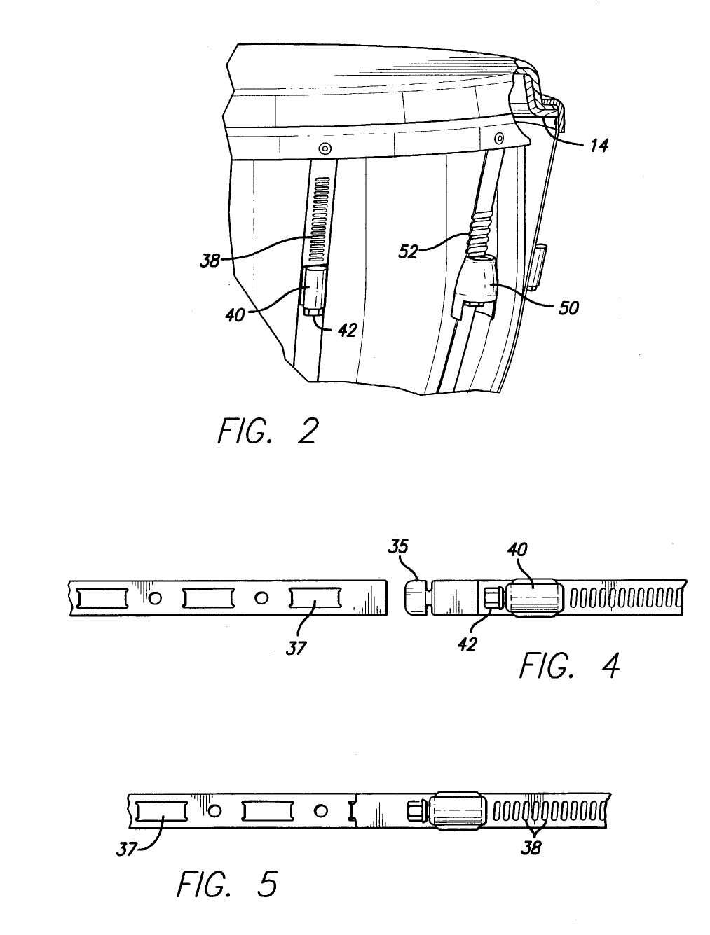

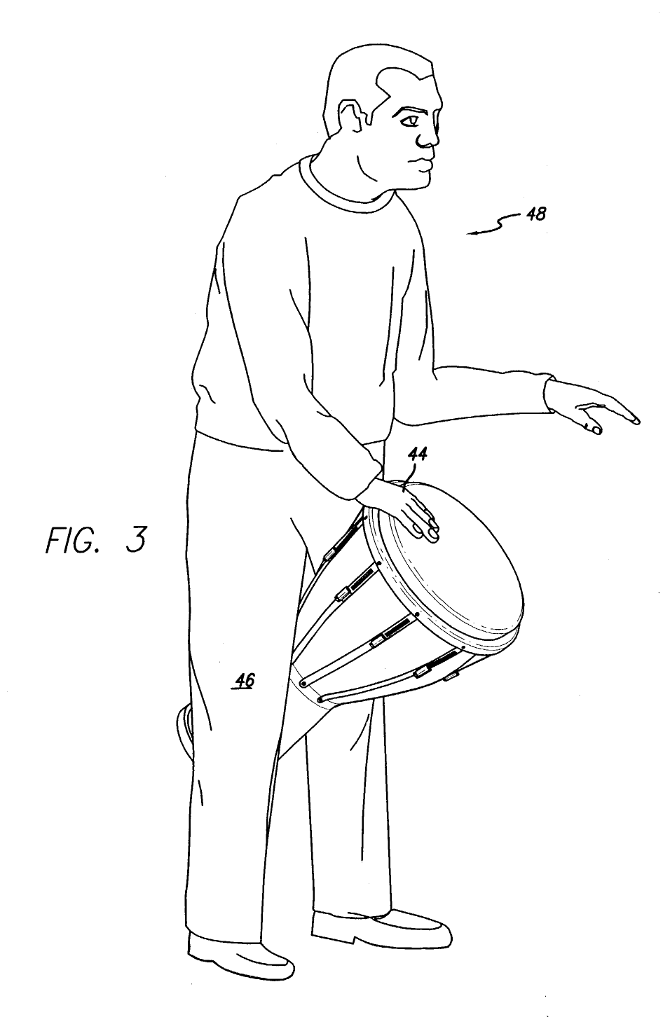

The preferred embodiment of the present invention shown in FIG. 1 provides a drum 10 comprising a drumshell 12, a flesh-hoop 14, a counter-hoop 16 and a drumhead 18 having a drumming surface 20. Also provided is a tensioning means 22 having a worm-drive 24 for applying a tensioning force to adjust the tension of drumming surface 20. Tensioning means 22 is affixed to drum 10 by attaching an end 26 to a position 28 on counter-hoop 16 and an end 30 to a position 32 on drumshell 12. Individual tensioning means 22 are placed and affixed generally equidistant from one another about the periphery of drumshell 12 to ensure an equal and balanced tensioning of drumhead 18.

Tensioning means 22 is comprised of various components, including an elongated ribbon-like band 34, a comparatively shorter ribbon-like band 36 having a plurality of transverse slotted openings 38 and, to connect the two bands, a t-shaped coupling member 35 defined at the end of ribbon-like band 36 and a plurality of mated openings 37 defined within and in a generally equidistant parallel relation along ribbon-like band 34. A conventional worm-drive device 40 also joins and secures bands 34 and 36. Device 40 includes a rotating screw 42, which can be caused to rotate in one direction to draw band 36 in toward worm-drive 40 to tension drumhead 18. Screw 42 is rotated in the opposite direction to relax the connection between worm-drive 40 and band 36 and reduce the tension in drumhead 18. Any conventional screw driver or wrench (not shown) can be employed to rotate screw 42.

Typically, tensioning means 22 is connected at each end to the drum 10 by any suitable means, including any appropriate screw, bolt or rivet 46. Counter-hoop 16, which is usually comprised of metal (e.g. steel), provides a solid anchor for attaching and securing tensioning means 22. Other similarly strong materials may also be used.

Tensioning means 22 is comprised of any lightweight, strong and resilient metal alloy or any suitable synthetic materials that are capable of withstanding the tensioning forces of approximately 5,000 pounds applied to the drumhead. To enhance the aesthetic appearance of worm-drive device 40 and either bands 34 or 36 or both, and to protect the drummer from the possibility of some pain or discomfort caused by protruding parts or exposed edges, rubber or synthetic covers are provided to encase these components. Specifically, protective cover 50 is provided to encase worm-drive device 40 and protective cover 52 is provided to encase band 36.

The device of the present invention is especially advantageous when used in conjunction with a drum played with the hands 44 and/or cradled between the drummer's legs 46, such as a Djembe. The use of the device of the present invention in lieu of a conventional tuning apparatus that employ protruding screws or rods adjacent the counterhoop, assists in the avoidance of injury to a drummer's hands that would result from the constant contact with the protruding metal objects. Moreover, the flat, low profile design and construction of the present invention makes it easier and more comfortable for the drummer 48 to cradle and support the instrument between the legs. Unlike a conventional tensioning apparatus, which includes a tensioning rod (not shown) that tends to protrude more as the head is tensioned, the device of the present invention maintains a compact in-line profile throughout.

While the invention will be described in connection with a certain preferred embodiment, it is to be understood that it is not intended to limit the invention to that particular embodiment. Rather, it is intended to cover all alternatives, modifications and equivalents as may be included within the spirit and scope of the invention as defined by the appended claims.

1. In combination with a drum having a drumshell, a flesh hoop, a counter-hoop, and a drumhead having a drumming surface,
a tensioning means comprising a worm-drive for applying a tensioning force to adjust the tension of the drumming surface, said tensioning means being substantially perpendicular to the drumming surface toward the flesh hoop to the counter-hoop and affixed to the drumshell and in contact with the counterhoop.

2. The invention as recited in claim 1 wherein the tensioning means is comprised of a plurality of non-protruding generally flat, ribbon-like bands disposed about the perimeter of the drumshell, each of said tensioning means including a series of spaced apart parallel slots in combination with said worm-drive for adjusting the tension in the drumming surface.

3. The invention as recited in claim 2 wherein said non-protruding ribbon-like band is comprised of two or more overlapping sections disposed flat and generally conforming to the contours of the drumshell and in combination with the worm-drive arranged in alignment with said band to enable the drummer's hands to contact the drumming surface without engaging a protruding component.

4. The invention as recited in claim 2 wherein said non-protruding ribbon-like band is comprised of two or more overlapping sections disposed flat and generally conforming to the contours of the drumshell and in combination with the worm-drive arranged in alignment with said band to enable a drummer to support the drumshell against said drummer's body or between said drummer's legs without engaging a protruding component.
